(19) United States
(12) Patent Application Publication
(10) Pub. No.: US 2026/0217021 A1
(43) Pub. Date: Jul. 30, 2026

(54) LIQUID EJECTING APPARATUS AND DRIVE UNIT

(71) Applicant: SEIKO EPSON CORPORATION, Tokyo (JP)

(72) Inventors: Kyo HORIE, Okaya (JP); Koichi KASHU, Shiojiri (JP); Toru MATSUYAMA, Matsumoto (JP)

(21) Appl. No.: 19/458,751

(22) Filed: Jan. 24, 2026

(30) Foreign Application Priority Data
Jan. 27, 2025 (JP) 2025-011309

(51) Int. Cl. B41J 2/045; B41J 29/377

(52) U.S. Cl. CPC B41J 2/04508; B41J 2/0451; B41J 2/04541; B41J 2/04548; B41J 2/0455; B41J 2/04581; B41J 2/04588; B41J 29/377

(57) ABSTRACT

A liquid ejecting apparatus includes: an ejection section that is driven by a drive signal and ejects liquid; a circuit substrate on which a drive circuit that generates the drive signal is disposed; a thermistor that is disposed on the circuit substrate and detects a temperature of the drive circuit; and a first thermally conductive member that is disposed on the circuit substrate, has an electrical insulation property, and has a first end coupled to the drive circuit, and a second end coupled to a wiring line electrically coupled to the thermistor.

The present application is based on, and claims priority from JP Application Serial Number 2025-011309, filed January 27, 2025, the disclosure of which is hereby incorporated by reference herein in its entirety.

### BACKGROUND

### 1. Technical Field

The present disclosure relates to a liquid ejecting apparatus and a drive unit.

### 2. Related Art

There is known a liquid ejecting apparatus including a drive circuit that generates a drive signal, and an ejection section that is driven by the drive signal and ejects liquid. In the liquid ejecting apparatus, since the drive signal for driving the ejection section has a large amplitude, the drive circuit generates heat at the time of the generation of the drive signal, and the temperature of the drive circuit becomes high. When the temperature of the drive circuit becomes high, the load on the drive circuit increases. Therefore, various techniques have been proposed in which the temperature of a drive circuit is detected, and when the temperature of the drive circuit becomes high, the load applied to the drive circuit is reduced. For example, JP-A-2017-042992 discloses a technique in which a thermistor is disposed in the vicinity of an electronic component constituting a drive circuit and detects the temperature of the electronic component, and when the temperature of the electronic component becomes high, the generation of a drive signal by the drive circuit is stopped.

However, according to the related art, since an insulating layer formed of an insulating resin such as glass epoxy is interposed between the electronic component and the thermistor, there is a possibility that heat generated by the electronic component cannot be sufficiently transferred to the thermistor and that the temperature of the drive circuit cannot be appropriately detected.

### SUMMARY

To solve the above-described issues, according to an aspect of the present disclosure, there is provided a liquid ejecting apparatus including: an ejection section that is driven by a drive signal and ejects liquid; a circuit substrate on which a drive circuit that generates the drive signal is disposed; a thermistor that is disposed on the circuit substrate and detects a temperature of the drive circuit; and a first thermally conductive member that is disposed on the circuit substrate, has an electrical insulation property, and has a first end coupled to the drive circuit, and a second end coupled to a wiring line electrically coupled to the thermistor.

According to another aspect of the present disclosure, there is provided a drive unit that drives an ejection section that ejects liquid, the drive unit including: a drive circuit that generates a drive signal for driving the ejection section; a circuit substrate on which the drive circuit is disposed; a thermistor that is disposed on the circuit substrate and detects a temperature of the drive circuit; and a first thermally conductive member that is disposed on the circuit substrate, has an electrical insulation property, and has a first end coupled to the drive circuit, and a second end coupled to a wiring line electrically coupled to the thermistor.

### BRIEF DESCRIPTION OF THE DRAWINGS

FIG. 1 is a block diagram illustrating an example of a configuration of an ink jet printer according to an embodiment of the present disclosure.

FIG. 2 is a perspective view illustrating an example of a schematic internal structure of the ink jet printer.

FIG. 3 is a cross-sectional view illustrating an example of a structure of an ejection section.

FIG. 4 is a block diagram illustrating an example of a configuration of a head unit.

FIG. 5 is a timing chart illustrating an example of signals supplied to the head unit.

FIG. 6 is an explanatory diagram illustrating an example of an individual specifying signal.

FIG. 7 is a block diagram illustrating an example of a configuration of a drive signal generating circuit.

FIG. 8 is a plan view illustrating an example of a configuration of a drive signal generation unit.

FIG. 9 is a cross-sectional view illustrating an example of a structure of the drive signal generation unit.

FIG. 10 is a plan view illustrating an example of a structure of a drive signal generation unit according to a first modification of the present disclosure.

FIG. 11 is a plan view illustrating an example of a structure of a drive signal generation unit according to a second modification of the present disclosure.

FIG. 12 is a block diagram illustrating an example of a configuration of a drive signal generating circuit according to a third modification of the present disclosure.

FIG. 13 is a plan view illustrating an example of a structure of a drive signal generation unit according to the third modification of the present disclosure.

FIG. 14 is a block diagram illustrating an example of a configuration of an ink jet printer according to a fourth modification of the present disclosure.

### DESCRIPTION OF EMBODIMENTS

Hereinafter, embodiments for carrying out the present disclosure will be described with reference to the drawings. However, in each drawing, the dimensions and scale of each section are appropriately different from the actual ones. In addition, since the embodiments described below are suitable specific examples of the present disclosure, the embodiments include various technically preferable limitations, but the scope of the present disclosure is not limited to the embodiments unless otherwise stated in the following description to particularly limit the present disclosure.

### A. Embodiments

A liquid ejecting apparatus will be described below using, as an example, an ink jet printer 1 that ejects ink to form an image on a recording sheet PP.

### A.1. Overview of Ink Jet Printer 1

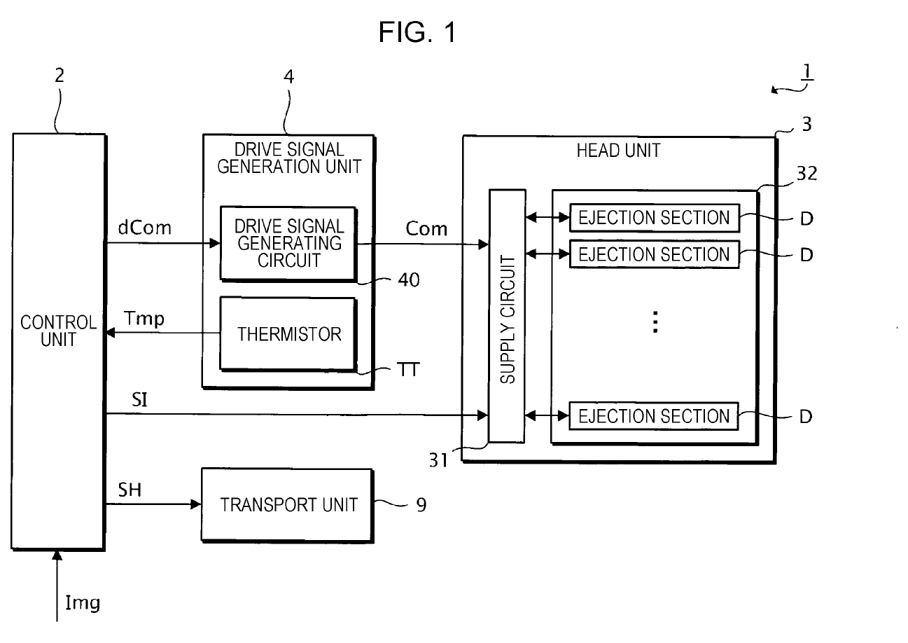

An example of a configuration of the ink jet printer 1 according to the present embodiment will be described with reference to FIGS. 1 to 3.

FIG. 1 is a functional block diagram illustrating the example of the configuration of the ink jet printer 1.

As illustrated in FIG. 1, print data Img indicating an image to be formed by the ink jet printer 1 is supplied to the ink jet printer 1 from a host computer such as a personal computer or a digital camera. The ink jet printer 1 executes a printing process of forming, on the recording sheet PP, the image indicated by the print data Img supplied from the host computer.

As illustrated in FIG. 1, the ink jet printer 1 includes a control unit 2 that controls each section of the ink jet printer 1, a head unit 3 including an ejection section D that ejects ink onto the recording sheet PP, a drive signal generation unit 4 including a drive signal generating circuit 40 that generates a drive signal Com for driving the ejection section D, and a transport unit 9 that transports the head unit 3 and the recording sheet PP.

In the present embodiment, the ink jet printer 1 is an example of a "liquid ejecting apparatus", the ink is an example of "liquid", the drive signal generation unit 4 is an example of a "drive unit", and the drive signal generating circuit 40 is an example of a "drive circuit".

In the present embodiment, it is assumed that the ink jet printer 1 includes one or a plurality of head units 3. Specifically, in the present embodiment, as an example, it is assumed that the ink jet printer 1 includes four head units 3. In addition, hereinafter, for convenience of description, as illustrated in FIG. 1, the following description may focus on one head unit 3 among the four head units 3.

In addition, in the present embodiment, it is assumed that the ink jet printer 1 includes one drive signal generation unit 4 corresponding to one head unit 3. That is, in the present embodiment, it is assumed that the ink jet printer 1 includes four drive signal generation units 4 corresponding to the four head units 3. However, the present disclosure is not limited to this aspect. The ink jet printer 1 may include two or more drive signal generation units 4 corresponding to one head unit 3. For convenience of description, as illustrated in FIG. 1, the following description may focus on one drive signal generation unit 4 among the four drive signal generation units 4.

The control unit 2 includes a control circuit (not illustrated) and a storage circuit (not illustrated).

The storage circuit includes a volatile memory such as a random-access memory (RAM) and a nonvolatile memory such as a read-only memory (ROM), an electrically erasable programmable read-only memory (EEPROM), or a programmable ROM (PROM), and stores various types of information such as a control program of the ink jet printer 1.

The control circuit includes one or a plurality of central processing units (CPUs). However, the control circuit may include a programmable logic device such as a field-programmable gate array (FPGA) instead of the one or plurality of CPUs or in addition to the one or plurality of CPUs. The control circuit executes the control program of the ink jet printer 1 stored in the storage circuit, and controls each section of the ink jet printer 1 by operating in accordance with the control program. Specifically, the control circuit generates signals for controlling the operation of each section of the ink jet printer 1. The signals are a specifying signal SI, a waveform specifying signal dCom, a transport control signal SH, and the like.

The waveform specifying signal dCom is a digital signal for defining a waveform of the drive signal Com. The drive signal Com is an analog signal for driving the ejection section D. The specifying signal SI is a digital signal specifying the type of operation of the ejection section D. Specifically, the specifying signal SI specifies whether or not the drive signal Com is supplied to the ejection section D, and thus specifies the type of operation of the ejection section D, for example, specifies whether ink is to be ejected from the ejection section D. The transport control signal SH is a signal for controlling the transport unit 9.

When the printing process is executed, the control unit 2 generates, based on the print data Img, a signal for controlling the head unit 3, such as the specifying signal SI. In addition, when the printing process is executed, the control unit 2 generates a signal for controlling the drive signal generation unit 4, such as the waveform specifying signal dCom. In addition, when the printing process is executed, the control unit 2 generates a signal for controlling the transport unit 9, such as the transport control signal SH. Accordingly, in the printing process, the control unit 2 controls each section of the ink jet printer 1 so as to form the image corresponding to the print data Img on the recording sheet PP by adjusting whether ink is ejected from the ejection section D, the timing of ejecting the ink, and the like while controlling the transport unit 9 so as to move the head unit 3 and the recording sheet PP.

As illustrated in FIG. 1, the head unit 3 includes a supply circuit 31 and a head section 32.

The head section 32 includes M ejection sections D. In this case, the value M is a natural number satisfying "M ≥ 1". In the following description, the m-th ejection section D among the M ejection sections D included in the head section 32 may be referred to as an ejection section D[m]. In this case, the variable m is a natural number satisfying "1 ≤ m ≤ M". In addition, in the following description, in a case where a component, signal, or the like of the ink jet printer 1 corresponds to the ejection section D[m] among the M ejection sections D, a subscript [m] may be added to a reference sign for representing the component, signal, or the like.

The supply circuit 31 switches whether to supply a drive signal Com to the ejection section D[m] based on the specifying signal SI. In the following description, among drive signals Com, the drive signal Com supplied to the ejection section D[m] may be referred to as a supply drive signal Vin[m].

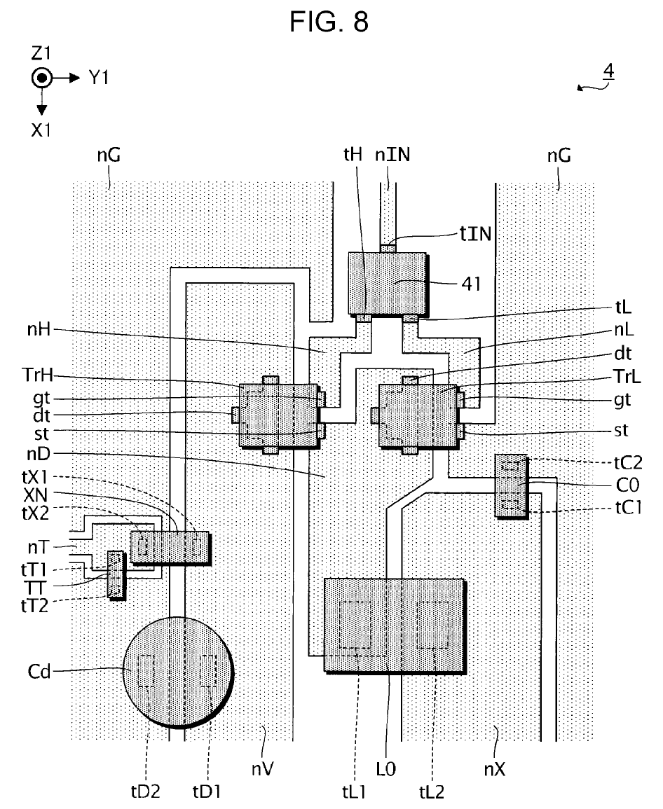

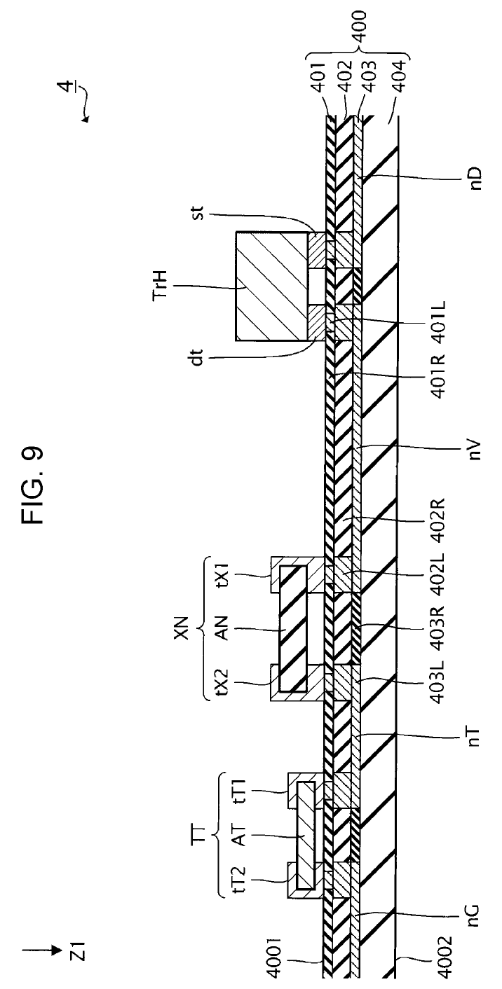

As illustrated in FIG. 1, the drive signal generation unit 4 includes the drive signal generating circuit 40 and a thermistor TT. In addition, although details will be described later with reference to FIGS. 8 and 9, the drive signal generation unit 4 includes a thermally conductive element XN for transferring heat of the drive signal generating circuit 40 to the thermistor TT, and a drive circuit substrate 400 on which the drive signal generating circuit 40, the thermistor TT, and the thermally conductive element XN are disposed. In the present embodiment, the drive circuit substrate 400 is an example of a "circuit substrate", and the thermally conductive element XN is an example of a "first thermally conductive member".

As described above, the drive signal generating circuit 40 generates the drive signal Com based on the waveform specifying signal dCom, and supplies the generated drive signal Com to the head unit 3. The thermistor TT detects the temperature of the drive signal generating circuit 40 and supplies a temperature signal Tmp indicating the detected temperature to the control unit 2.

In the present embodiment, the control unit 2 estimates the temperature of the drive signal generating circuit 40 based on the temperature signal Tmp supplied from the drive signal generation unit 4 during the execution of the printing process. Then, when the temperature of the drive signal generating circuit 40 estimated based on the temperature signal Tmp is equal to or lower than a predetermined temperature, the control unit 2 continuously executes the printing process. On the other hand, when the temperature of the drive signal generating circuit 40 estimated based on the temperature signal Tmp becomes higher than the predetermined temperature, the control unit 2 temporarily stops the printing process. Thereafter, when the temperature of the drive signal generating circuit 40 estimated based on the temperature signal Tmp returns to a temperature lower than or equal to the predetermined temperature, the control unit 2 restarts the printing process.

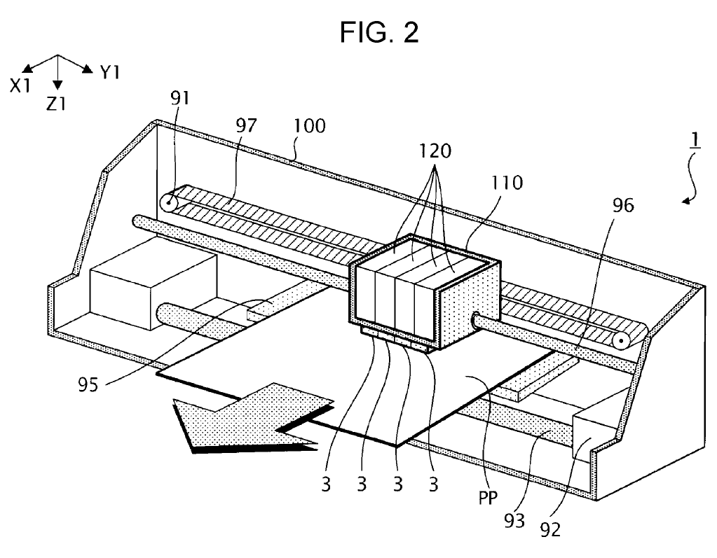

FIG. 2 is a perspective view illustrating an example of a schematic internal structure of the ink jet printer 1.

As illustrated in FIG. 2, in the present embodiment, it is assumed that the ink jet printer 1 is a serial printer. Specifically, when executing the printing process, the ink jet printer 1 forms the image corresponding to the print data Img on the recording sheet PP by ejecting ink from the head unit 3 while transporting the recording sheet PP in an X1 direction and moving the head unit 3 in a Y1 direction intersecting the X1 direction or in a Y2 direction opposite to the Y1 direction.

In the following, the X1 direction and an X2 direction opposite to the X1 direction are collectively referred to as an "X-axis direction", the Y1 direction intersecting the X-axis direction and the Y2 direction opposite to the Y1 direction are collectively referred to as a "Y-axis direction", and a Z1 direction intersecting the X-axis direction and the Y-axis direction and a Z2 direction opposite to the Z1 direction is collectively referred to as a "Z-axis direction". In the present embodiment, as an example, it is assumed that the X-axis direction, the Y-axis direction, and the Z-axis direction are orthogonal to each other. However, the present disclosure is not limited to this aspect. The X-axis direction, the Y-axis direction, and the Z-axis direction may intersect each other. In the present embodiment, the Z1 direction is a direction in which the ink is ejected from the ejection section D[m].

As illustrated in FIG. 2, the ink jet printer 1 according to the present embodiment includes a housing 100 and a carriage 110. The carriage 110 is capable of reciprocating in the Y-axis direction in the housing 100.

As illustrated in FIG. 2, in the present embodiment, it is assumed that four ink cartridges 120 corresponding one-to-one to ink of four colors of cyan, magenta, yellow, and black are mounted on the carriage 110. In addition, in the present embodiment, as described above, it is assumed that the four head units 3 corresponding one-to-one to the four ink cartridges 120 are mounted on the carriage 110. Each ejection section D[m] receives ink supplied from the ink cartridge 120 corresponding to the head unit 3 including the ejection section D[m]. As a result, each ejection section D[m] is filled with the supplied ink and can eject the ink filled in the ejection section D[m] from a nozzle N[m] disposed in the ejection section D[m]. The ink cartridge 120 may be provided outside the carriage 110.

In addition, as described above, the ink jet printer 1 according to the present embodiment includes the transport unit 9. As illustrated in FIG. 2, the transport unit 9 includes a carriage transport motor 91, a medium transport motor 92, a medium transport mechanism 93, a platen 95, a carriage guide shaft 96, and a carriage transport mechanism 97. The carriage transport motor 91 drives the carriage transport mechanism 97 based on the transport control signal SH. The carriage transport mechanism 97 is, for example, a belt, and transports the carriage 110 in the Y-axis direction based on the driving of the carriage transport motor 91. The carriage guide shaft 96 supports the carriage 110 such that the carriage 110 is capable of reciprocating in the Y-axis direction. The medium transport motor 92 drives the medium transport mechanism 93 based on the transport control signal SH. The medium transport mechanism 93 transports the recording sheet PP in the X1 direction by rotating based on the driving of the medium transport motor 92. The platen 95 is disposed in the Z1 direction with respect to the carriage 110, and supports the recording sheet PP transported by the medium transport mechanism 93. As described above, when the printing process is executed, the transport unit 9 causes the head unit 3 to reciprocate together with the carriage 110 in the Y-axis direction along the carriage guide shaft 96 by the carriage transport motor 91 and transports the recording sheet PP on the platen 95 in the X1 direction by the medium transport motor 92 so as to change the relative position of the recording sheet PP to the head unit 3, thereby making it possible for the ink to land on the entire recording sheet PP.

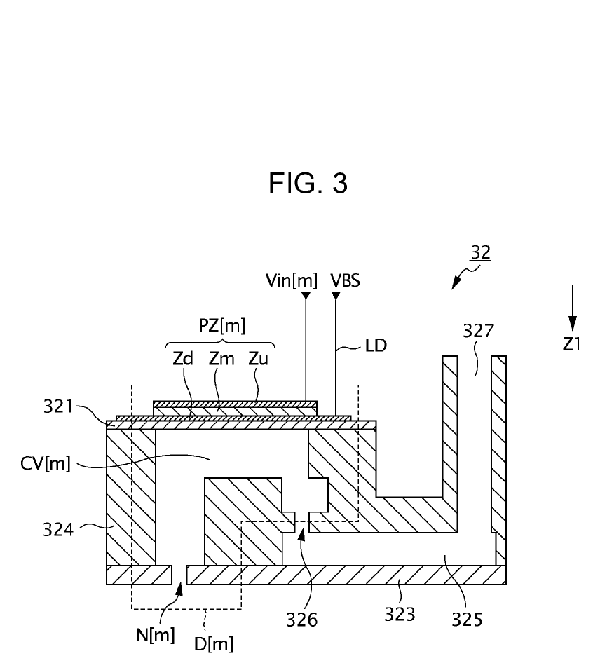

FIG. 3 is a schematic partial cross-sectional view of the head section 32, in which the head section 32 is taken so as to include the ejection section D[m].

As illustrated in FIG. 3, the ejection section D[m] includes a piezoelectric element PZ[m], a cavity CV[m] filled with ink, a nozzle N[m] that communicating with the cavity CV[m], and a vibration plate 321. The ejection section D[m] ejects the ink in the cavity CV[m] from the nozzle N[m] when the piezoelectric element PZ[m] is driven by the supply drive signal Vin[m]. The cavity CV[m] is a space partitioned by a cavity plate 324, a nozzle plate 323 in which the nozzle N[m] is formed, and the vibration plate 321. The cavity CV[m] communicates with a reservoir 325 via an ink supply port 326. The reservoir 325 communicates with the ink cartridge 120 corresponding to the ejection section D[m] via an ink intake port 327. The piezoelectric element PZ[m] includes an upper electrode Zu[m], a lower electrode Zd[m], and a piezoelectric body Zm[m] disposed between the upper electrode Zu[m] and the lower electrode Zd[m]. The lower electrode Zd[m] is electrically coupled to a power supply line LD set to a predetermined electrical potential VBS. When the supply drive signal Vin[m] is supplied to the upper electrode Zu[m] and a voltage is applied between the upper electrode Zu[m] and the lower electrode Zd[m], the piezoelectric element PZ[m] is deformed in the Z1 direction and the Z2 direction in accordance with the applied voltage, and as a result, the piezoelectric element PZ[m] vibrates. The lower electrode Zd[m] is joined to the vibration plate 321. Therefore, when the piezoelectric element PZ[m] is driven by the supply drive signal Vin[m] and vibrates, the vibration plate 321 also vibrates. The vibration of the vibration plate 321 changes the volume of the cavity CV[m] and the pressure in the cavity CV[m], and the ink that fills the cavity CV[m] is ejected from the nozzle N[m].

### A.2. Configuration and Operation of Head Unit 3

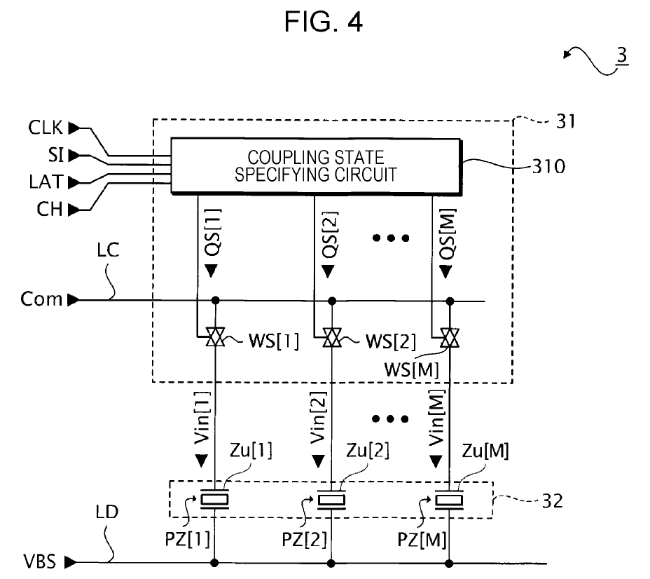

An example of a configuration and an operation of the head unit 3 will be described below with reference to FIGS. 4 to 6.

FIG. 4 is a block diagram illustrating an example of the configuration of the head unit 3.

As illustrated in FIG. 4, the head unit 3 includes the supply circuit 31 and the head section 32. The head unit 3 includes a wiring line LC through which the drive signal Com from the drive signal generation unit 4 is supplied.

As illustrated in FIG. 4, the supply circuit 31 includes M switches WS[1] to WS[M] corresponding one-to-one to the M ejection sections D[1] to D[M], and a coupling state specifying circuit 310 that specifies a coupling state of each of the switches WS[1] to WS[M].

The coupling state specifying circuit 310 generates a coupling state specifying signal QS[m] that specifies turning on or off of the switch WS[m] based on at least one of the specifying signal SI, the latch signal LAT, the change signal CH, and the clock signal CLK supplied from the control unit 2.

The switch WS[m] switches between conduction and non-conduction between the wiring line LC and the upper electrode Zu[m] of the piezoelectric element PZ[m] included in the ejection section D[m], based on the coupling state specifying signal QS[m]. In the present embodiment, the switch WS[m] is on when the coupling state specifying signal QS[m] is at a high level, and is off when the coupling state specifying signal QS[m] is at a low level. When the switch WS[m] is turned on, the drive signal Com supplied to the wiring line LC is supplied to the upper electrode Zu[m] of the ejection section D[m] as the supply drive signal Vin[m].

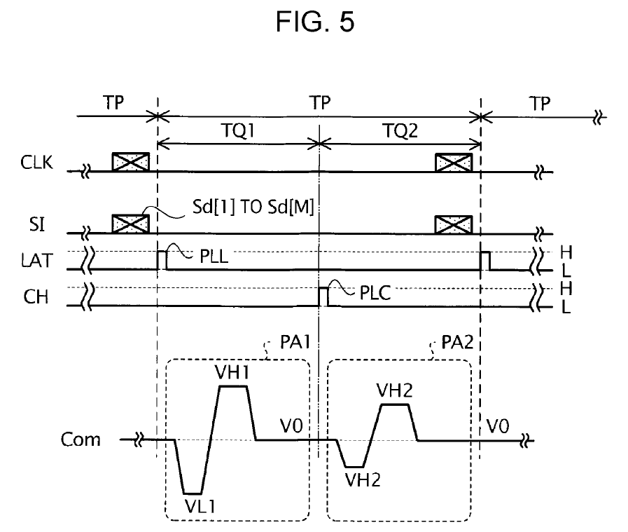

FIG. 5 is a timing chart illustrating an example of various signals supplied to the head unit 3, such as the drive signal Com.

As illustrated in FIG. 5, when the ink jet printer 1 executes the printing process, one or a plurality of unit periods TP are set as an operation period of the ink jet printer 1. In the present embodiment, the ink jet printer 1 can drive each ejection section D[m] for the printing process in each unit period TP.

As illustrated in FIG. 5, the control unit 2 outputs the latch signal LAT having a pulse PLL. Accordingly, the control unit 2 defines the unit period TP as a period from a rising edge of the pulse PLL to a rising edge of the next pulse PLL. The control unit 2 outputs the change signal CH having a pulse PLC in the unit period TP. The control unit 2 divides the unit period TP into a drive period TQ1 from the rising edge of the pulse PLL to a rising edge of the pulse PLC and a drive period TQ2 from the rising edge of the pulse PLC to the rising edge of the next pulse PLL.

As illustrated in FIG. 5, the specifying signal SI includes M individual specifying signals Sd[1] to Sd[M] corresponding one-to-one to the M ejection sections D[1] to D[M]. The individual specifying signal Sd[m] specifies a mode of driving the ejection section D[m] in each unit period TP when the ink jet printer 1 executes the printing process. The control unit 2 supplies the specifying signal SI including the M individual specifying signals Sd[1] to Sd[M] to the coupling state specifying circuit 310 in synchronization with the clock signal CLK prior to each unit period TP. The coupling state specifying circuit 310 generates the coupling state specifying signal QS[m] based on the individual specifying signal Sd[m] in the unit period TP.

In the present embodiment, it is assumed that the ejection section D[m] can form any one of a large dot of ink in an amount ξ1, a medium dot of ink in an amount ξ2 less than the amount ξ1, and a small dot of ink in an amount ξ3 less than the amount ξ2 in the unit period TP in which the printing process is executed.

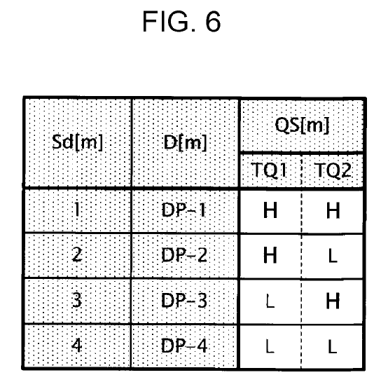

FIG. 6 is an explanatory diagram illustrating an example of the individual specifying signal Sd[m].

As illustrated in FIG. 6, in the present embodiment, the individual specifying signal Sd[m] can take any one of four values that are a value "1" that specifies the ejection section D[m] as a large dot forming ejection section DP-1, a value "2" that specifies the ejection section D[m] as a medium dot forming ejection section DP-2, a value "3" that specifies the ejection section D[m] as a small dot forming ejection section DP-3, and a value "4" that specifies the ejection section D[m] as a non-dot forming ejection section DP-4 in the unit period TP in which the printing process is executed.

The large dot forming ejection section DP-1 is an ejection section D that forms the large dot in the unit period TP. The medium dot forming ejection section DP-2 is an ejection section D that forms the medium dot in the unit period TP. The small dot forming ejection section DP-3 is an ejection section D that forms the small dot in the unit period TP. The non-dot forming ejection section DP-4 is an ejection section D that does not form a dot in the unit period TP.

Return to the description of FIG. 5.

As illustrated in FIG. 5, in the present embodiment, the drive signal Com has a waveform PA1 in the drive period TQ1 and a waveform PA2 in the drive period TQ2.

The waveform PA1 is a waveform in which an electrical potential returns from an electrical potential V0 to the electrical potential V0 through an electrical potential VL1 lower than the electrical potential V0 and an electrical potential VH1 higher than the electrical potential V0. When the supply drive signal Vin[m] having the waveform PA1 is to be supplied to the ejection section D[m], the waveform PA1 is determined such that ink in an amount corresponding to an amount φ1 is ejected from the ejection section D[m]. The waveform PA2 is a waveform in which the electrical potential returns from the electrical potential V0 to the electrical potential V0 through an electrical potential VL2 lower than the electrical potential V0 and an electrical potential VH2 higher than the electrical potential V0. When the supply drive signal Vin[m] having the waveform PA2 is to be supplied to the ejection section D[m], the waveform PA2 is determined such that ink in an amount corresponding to an amount φ2 is ejected from the ejection section D[m]. In the present embodiment, it is assumed that the amount ξ1 corresponds to the sum of the amount φ1 and the amount φ2, the amount ξ2 corresponds to the amount φ1, and the amount ξ3 corresponds to the amount φ2.

In addition, in the present embodiment, as an example, it is assumed that when the electrical potential of the supply drive signal Vin[m] supplied to the ejection section D[m] is high, the volume of the cavity CV[m] included in the ejection section D[m] is smaller than that in a case where the electrical potential of the supply drive signal Vin[m] supplied to the ejection section D[m] is low. Therefore, when the ejection section D[m] is driven by the supply drive signal Vin[m] having the waveform PA1 or the like, the electrical potential of the supply drive signal Vin[m] changes from a low electrical potential to a high electrical potential, and thus the ink in the ejection section D[m] is ejected from the nozzle N[m].

As illustrated in FIG. 6, when the individual specifying signal Sd[m] indicates the value "1" that specifies the ejection section D[m] as the large dot forming ejection section DP-1 in the unit period TP, the coupling state specifying circuit 310 sets the coupling state specifying signal QS[m] to a high level in the drive period TQ1 and the drive period TQ2. In this case, the switch WS[m] is on in the drive period TQ1 and the drive period TQ2. Therefore, the ejection section D[m] is driven by the supply drive signal Vin[m] having the waveform PA1 and the waveform PA2 in the unit period TP, and ejects the ink in the amount ξ1 corresponding to the large dot.

In addition, when the individual specifying signal Sd[m] indicates the value "2" that specifies the ejection section D[m] as the medium dot forming ejection section DP-2 in the unit period TP, the coupling state specifying circuit 310 sets the coupling state specifying signal QS[m] to a high level in the drive period TQ1. In this case, the switch WS[m] is on in the drive period TQ1. Therefore, the ejection section D[m] is driven by the supply drive signal Vin[m] having the waveform PA1 in the unit period TP, and ejects the ink in the amount ξ2 corresponding to the medium dot.

In addition, when the individual specifying signal Sd[m] indicates the value "3" that specifies the ejection section D[m] as the small dot forming ejection section DP-3 in the unit period TP, the coupling state specifying circuit 310 sets the coupling state specifying signal QS[m] to a high level in the drive period TQ2. In this case, the switch WS[m] is on in the drive period TQ2. Therefore, the ejection section D[m] is driven by the supply drive signal Vin[m] having the waveform PA2 in the unit period TP, and ejects the ink in the amount ξ3 corresponding to the small dot.

In addition, when the individual specifying signal Sd[m] indicates the value "4" that specifies the ejection section D[m] as the non-dot forming ejection section DP-4 in the unit period TP, the coupling state specifying circuit 310 sets the coupling state specifying signal QS[m] to a low level for the unit period TP. In this case, the switch WS[m] is off for the unit period TP. Therefore, the ejection section D[m] is not driven by the supply drive signal Vin[m] and does not eject the ink in the unit period TP.

### A.3. Configuration of Drive Signal Generating Circuit 40

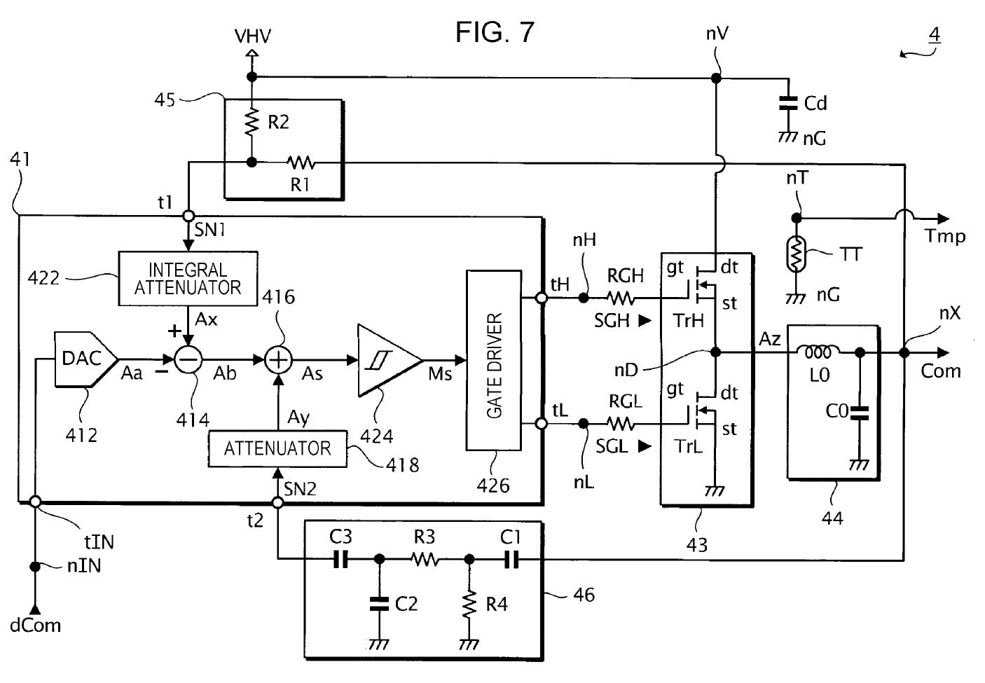

An example of a configuration of the drive signal generating circuit 40 and the thermistor TT disposed in the drive signal generation unit 4 will be described with reference to FIG. 7.

FIG. 7 is a block diagram illustrating an example of a circuit configuration of the drive signal generating circuit 40 and the thermistor TT disposed in the drive signal generation unit 4.

As illustrated in FIG. 7, the drive signal generating circuit 40 includes an integrated circuit 41, an amplifier circuit 43, a smoothing circuit 44, a pull-up circuit 45, and a filter circuit 46, and is a class-D amplifier circuit that generates the drive signal Com based on the waveform specifying signal dCom.

The integrated circuit 41 is, for example, a large-scale integration (LSI) circuit, and generates a gate signal SGH and a gate signal SGL based on the waveform specifying signal dCom supplied to a terminal tIN through a node nIN. The integrated circuit 41 includes an analog conversion circuit 412, a subtractor 414, an adder 416, an attenuator 418, an integral attenuator 422, a comparator 424, and a gate driver 426.

The analog conversion circuit 412 is a digital-to-analog converter (DAC), and converts the digital waveform specifying signal dCom into an analog signal Aa. The voltage amplitude of the signal Aa is, for example, about 0 volts to 2 volts, and a signal obtained by amplifying the voltage of the signal Aa by about 20 times is the drive signal Com. That is, the signal Aa is a signal before the amplification of the drive signal Com.

The integral attenuator 422 outputs a signal Ax obtained by attenuating and integrating a signal SN1 input to a terminal t1 described later.

The subtractor 414 outputs a signal Ab indicating an electrical potential obtained by subtracting the electrical potential of the signal Aa from the electrical potential of the signal Ax.

The attenuator 418 outputs a signal Ay obtained by attenuating a high-frequency component of a signal SN2 input to a terminal t2 described later.

The adder 416 outputs a signal As indicating an electrical potential obtained by adding the electrical potential of the signal Ab to the electrical potential of the signal Ay.

The comparator 424 outputs a modulated signal Ms obtained by pulse-modulating the signal As. Specifically, the comparator 424 outputs the modulated signal Ms that becomes a high level when the voltage of the signal As increases and becomes greater than or equal to a threshold voltage Vth1, and that becomes a low level when the voltage of the signal As decreases and becomes less than a threshold voltage Vth2. The threshold voltage Vth1 and the threshold voltage Vth2 are set to have a relationship of "Vth1 > Vth2".

Note that a power supply voltage of a circuit from the analog conversion circuit 412 to the comparator 424 is a low voltage such as 3.3 volts. Meanwhile, the drive signal Com has a large amplitude, and may exceed 40 volts, for example. Therefore, the integral attenuator 422 attenuates the signal SN1 having an amplitude corresponding to the drive signal Com, and matches an amplitude range of the signal Ax with an amplitude range of a signal in the circuit from the analog conversion circuit 412 to the comparator 424.

In the present embodiment, the digital signal is described as an example of the waveform specifying signal dCom. However, the waveform specifying signal dCom may be any signal that defines a target value for generating the drive signal Com, and for example, the analog signal Aa may be the waveform specifying signal dCom. In a case where the signal Aa is the waveform specifying signal dCom, the integrated circuit 41 may not include the analog conversion circuit 412.

The gate driver 426 outputs the gate signal SGH obtained by converting the modulated signal Ms into a specific amplitude to a node nH through a terminal tH. The gate driver 426 outputs the gate signal SGL obtained by converting a signal obtained by inverting the logic level of the modulated signal Ms into a specific amplitude to a node nL through a terminal tL.

The amplifier circuit 43 includes, for example, a transistor TrH and a transistor TrL, and generates an amplified signal Az obtained by amplifying the modulated signal Ms, based on the gate signal SGH and the gate signal SGL output from the integrated circuit 41. In the present embodiment, as an example, it is assumed that the transistor TrH and the transistor TrL are field-effect transistors. More specifically, in the present embodiment, it is assumed that N-channel type metal-oxide-semiconductor field-effect transistors (MOSFETs) are used as the transistor TrH and the transistor TrL.

The gate signal SGH output from the gate driver 426 to the terminal tH is input to a gate electrode gt of the transistor TrH through the node nH and a resistor RGH. The gate signal SGL output from the gate driver 426 to the terminal tL is input to a gate electrode gt of the transistor TrL through the node nL and a resistor RGL. The logic level of the gate signal SGH and the logic level of the gate signal SGL are mutually exclusive. In this case, "being mutually exclusive" means that the signal level of the gate signal SGH supplied to the gate electrode gt of the transistor TrH and the signal level of the gate signal SGL supplied to the gate electrode gt of the transistor TrL are not a high level at the same time, in other words, the transistor TrH and the transistor TrL are not on at the same time. The transistor TrH is on when the electrical potential of the gate electrode gt of the transistor TrH is at a high level, and is off when the electrical potential of the gate electrode gt of the transistor TrH is at a low level. The transistor TrL is on when the electrical potential of the gate electrode gt of the transistor TrL is at a high level, and is off when the electrical potential of the gate electrode gt of the transistor TrL is at a low level.

A drain electrode dt of the transistor TrH is electrically coupled to a node nV set to a power supply electrical potential VHV on the high electrical potential side, and a source electrode st of the transistor TrH is electrically coupled to a node nD. A source electrode st of the transistor TrL is electrically coupled to a node nG set to a ground electrical potential, and a drain electrode dt of the transistor TrL is electrically coupled to the node nD. Note that the source electrode of the transistor TrL may be electrically coupled to the power supply line LD set to the electrical potential VBS.

As described above, the transistor TrH is on when the gate signal SGH supplied to the gate electrode gt of the transistor TrH is at a high level, and is off when the gate signal SGH supplied to the gate electrode gt of the transistor TrH is at a low level. The transistor TrL is on when the gate signal SGL supplied to the gate electrode gt of the transistor TrL is at a high level, and is off when the gate signal SGL supplied to the gate electrode gt of the transistor TrL is at a low level. Therefore, the amplified signal Az obtained by amplifying the modulated signal Ms is output to the node nD electrically coupling the source electrode st of the transistor TrH and the drain electrode dt of the transistor TrL.

In the present embodiment, the transistor TrH and the transistor TrL are examples of "two transistors", the transistor TrH is an example of a "first transistor", the transistor TrL is an example of a "second transistor", the power supply electrical potential VHV is an example of a "first electrical potential", the node nV is an example of a "first electrical potential line", the ground electrical potential is an example of a "second electrical potential", and the node nG is an example of a "second electrical potential line".

An electrolytic capacitor Cd is coupled to the node nV to which the power supply electrical potential VHV is supplied. The electrolytic capacitor Cd has a first end (terminal tD1) electrically coupled to the node nV, and a second end (terminal tD2) electrically coupled to the node nG set to the ground electrical potential. In the present embodiment, the electrolytic capacitor Cd is, for example, a large-capacity aluminum electrolytic capacitor, and suppresses a fluctuation in the electrical potential at the node nV to stabilize the power supply electrical potential VHV. The terminals tD1 and tD2 will be described later with reference to FIG. 8.

The smoothing circuit 44 is a low pass filter (LPF), smooths the amplified signal Az to generate the drive signal Com, and outputs the generated drive signal Com to a node nX. The smoothing circuit 44 includes an inductor L0 and a capacitor C0. The inductor L0 has a first end (terminal tL1) electrically coupled to the node nD, and a second end (terminal tL2) electrically coupled to the node nX. The capacitor C0 has a first end (terminal tC1) electrically coupled to the node nX, and a second end (terminal tC2) electrically coupled to the node nG set to the ground electrical potential. The node nX is electrically coupled to the wiring line LC. The terminals tL1 and tL2 and the terminals tC1 and tC2 will be described later with reference to FIG. 8.

The pull-up circuit 45 feeds back, to the terminal t1, the signal SN1 obtained by pulling up the drive signal Com output to the node nX. The pull-up circuit 45 includes a resistor R1 having a first end electrically coupled to the node nX and a second end electrically coupled to the terminal t1, and a resistor R2 having a first end electrically coupled to the terminal t1 and a second end electrically coupled to the node nV set to the power supply electrical potential VHV.

The filter circuit 46 is a band pass filter (BPF), and feeds back, to the terminal t2, the signal SN2 obtained by removing a direct-current component from a frequency component included in the drive signal Com and having a frequency in a predetermined band. The filter circuit 46 includes a resistor R3, a capacitor C1, a resistor R4, a capacitor C2, and a capacitor C3. The capacitor C1 has a first end electrically coupled to the node nX, and a second end electrically coupled to a first end of the resistor R3. The resistor R4 has a first end electrically coupled to the first end of the resistor R3, and a second end electrically coupled to the node nG set to the ground electrical potential. The capacitor C2 has a first end electrically coupled to a second end of the resistor R3, and a second end electrically coupled to the node nG set to the ground electrical potential. The capacitor C3 has a first end electrically coupled to the second end of the resistor R3, and a second end electrically coupled to the terminal t2. Among these, the capacitor C1 and the resistor R4 function as a high pass filter (HPF) that passes a high-frequency component included in the drive signal Com and having a frequency higher than or equal to a cutoff frequency of the HPF. The resistor R3 and the capacitor C2 function as a low-pass filter (LPF) that passes a low-frequency component included in the drive signal Com and having a frequency lower than or equal to a cutoff frequency of the LPF. In the present embodiment, in the filter circuit 46, the cutoff frequency of the HPF is set to be lower than the cutoff frequency of the LPF. Therefore, the filter circuit 46 passes a frequency component included in the drive signal Com and having a frequency that is in the predetermined band and higher than or equal to the cutoff frequency of the HPF and lower than or equal to the cutoff frequency of the LPF. In addition, since the filter circuit 46 includes the capacitor C3, the filter circuit 46 feeds back, to the terminal t2, a signal obtained by removing a direct-current component from a signal included in the drive signal Com, having passed through the HPF and the LPF, and having a frequency component in the predetermined band.

In this way, the drive signal generating circuit 40 generates the drive signal Com by smoothing the amplified signal Az at the node nD by the smoothing circuit 44. The drive signal Com is integrated and attenuated by the integral attenuator 422, and then fed back to the subtractor 414. Therefore, the drive signal generating circuit 40 self-oscillates at a frequency determined by a delay in the smoothing circuit 44, a delay in the integral attenuator 422, and a transfer function for the feedback. However, since the amount of a delay in a feedback path extending through the terminal t1 is large, it is not possible to increase the frequency of the self-oscillation only by the feedback through the terminal t1 to the extent that the accuracy of the waveform of the drive signal Com can be sufficiently secured. On the other hand, in the present embodiment, since a path for feeding back a high-frequency component of the drive signal Com through the terminal t2 is disposed separately from the path extending through the terminal t1, it is possible to reduce a delay in the feedback in the entire drive signal generating circuit 40. That is, in the present embodiment, the frequency of the signal As obtained by adding the signal Ay, which is the high-frequency component of the drive signal Com, to the signal Ab can be increased, as compared to a case where the path extending through the terminal t2 is not present, and thus it is possible to sufficiently secure the accuracy of the drive signal Com.

As illustrated in FIG. 7, the thermistor TT has a first end (terminal tT1) electrically coupled to a node nT, and a second end (terminal tT2) electrically coupled to the node nG. An electric resistance value between the terminal tT1 and the terminal tT2 of the thermistor TT is a value corresponding to the temperature of the thermistor TT. Therefore, it is possible to identify the temperature of the thermistor TT based on the difference in electrical potential between the terminal tT1 and the terminal tT2 of the thermistor TT or a current flowing between the terminals tT1 and tT2 of the thermistor TT. In the present embodiment, as an example, it is assumed that the temperature signal Tmp supplied from the thermistor TT to the control unit 2 indicates the electrical potential of the node nT determined based on the difference in electrical potential between the terminal tT1 and the terminal tT2 (that is, the difference in electrical potential between the node nG and the node nT). The terminals tT1 and tT2 will be described later with reference to FIG. 8.

### A.4. Configuration of Drive Signal Generation Unit 4

A configuration of the drive signal generation unit 4 will be described with reference to FIGS. 8 and 9.

FIG. 8 is a plan view illustrating an example of a wiring pattern of the drive signal generating circuit 40 and the thermistor TT when the drive circuit substrate 400 that is included in the drive signal generation unit 4 and on which the drive signal generating circuit 40 is disposed is viewed in plan view. FIG. 8 does not illustrate some of electronic components of the drive signal generating circuit 40. A case where the drive circuit substrate 400 is disposed on a flat surface whose normal direction is the Z1 direction will be described as an example with reference to FIG. 8, but the present disclosure is not limited to this aspect. The normal direction of the drive circuit substrate 400 may be any direction.

As illustrated in FIG. 8, the terminal tIN of the integrated circuit 41 is coupled to the node nIN. The terminal tH of the integrated circuit 41 is electrically coupled to the gate electrode gt of the transistor TrH via the node nH, and the terminal tL of the integrated circuit 41 is electrically coupled to the gate electrode gt of the transistor TrL via the node nL.

The source electrode st of the transistor TrL is electrically coupled to the node nG. The drain electrode dt of the transistor TrL is electrically coupled to the source electrode st of the transistor TrH and the terminal tL1 of the inductor L0 via the node nD. The terminal tL2 of the inductor L0 is electrically coupled to the terminal tC1 of the capacitor C0 via the node nX. The terminal tC2 of the capacitor C0 is electrically coupled to the node nG.

The drain electrode dt of the transistor TrH is electrically coupled to the terminal tD1 of the electrolytic capacitor Cd via the node nV. The terminal tD2 of the electrolytic capacitor Cd is electrically coupled to the node nG.

As illustrated in FIG. 8, the terminal tT1 of the thermistor TT is coupled to the node nT. The terminal tT2 of the thermistor TT is coupled to the node nG. The temperature signal Tmp indicating a value corresponding to the temperature of the thermistor TT is supplied from the node nT to the control unit 2.

As illustrated in FIG. 8, the thermally conductive element XN is disposed on the drive circuit substrate 400. The thermally conductive element XN includes a terminal tX1 and a terminal tX2, transfers heat between the terminal tX1 and the terminal tX2, and electrically insulates the terminal tX1 and the terminal tX2 from each other. The terminal tX1 of the thermally conductive element XN is coupled to the node nV. The terminal tX2 of the thermally conductive element XN is coupled to the node nT. That is, in the present embodiment, the thermally conductive element XN thermally couples the node nV and the node nT, while electrically decoupling the node nV and the node nT. In the present embodiment, the node nV is an example of a "coupling wiring line".

Therefore, in the present embodiment, heat generated from the drain electrode dt of the transistor TrH is transferred to the thermistor TT via the node nV, the thermally conductive element XN, and the node nT. Accordingly, in the embodiment, it is possible to set the temperature signal Tmp output from the thermistor TT as a signal that accurately indicates the temperature of the transistor TrH in the drive signal generating circuit 40.

FIG. 9 is a cross-sectional view illustrating an example of a configuration of the drive signal generation unit 4. Specifically, FIG. 9 is a cross-sectional view of the drive signal generation unit 4 taken along a cross section including a polygonal line extending through the transistor TrH, the thermally conductive element XN, and the thermistor TT when the drive circuit substrate 400 is viewed in the Z1 direction.

As illustrated in FIG. 9, the drive signal generation unit 4 includes the drive circuit substrate 400, the drive signal generating circuit 40 including the transistor TrH, the thermistor TT, and the thermally conductive element XN.

The drive circuit substrate 400 includes an upper substrate surface 4001 on which the drive signal generating circuit 40 is disposed, and a lower substrate surface 4002 opposite to the upper substrate surface 4001. In the present embodiment, it is assumed that the drive circuit substrate 400 is a multilayer substrate. Specifically, in the present embodiment, the drive circuit substrate 400 includes a plurality of layers including a surface layer 401, an insulating layer 402, a wiring layer 403, and a protective layer 404 that are disposed between the upper substrate surface 4001 and the lower substrate surface 4002.

The surface layer 401 includes the upper substrate surface 4001, and includes a wiring line 401L and a resist 401R. The wiring line 401L is made of a conductive material such as copper or aluminum, for example. The resist 401R is made of, for example, an insulating resin such as an epoxy resin.

The insulating layer 402 is disposed between the surface layer 401 and the lower substrate surface 4002, and includes a wiring line 402L and an insulating portion 402R. The wiring line 402L is made of a conductive material such as copper or aluminum, for example. The insulating portion 402R is made of, for example, an insulating resin such as an epoxy resin.

The wiring layer 403 is disposed between the insulating layer 402 and the lower substrate surface 4002, and includes a wiring line 403L and an insulating portion 403R. The wiring line 403L is made of a conductive material such as copper or aluminum, for example. The insulating portion 403R is made of, for example, an insulating resin such as an epoxy resin.

The protective layer 404 includes the lower substrate surface 4002, and is made of, for example, an insulating resin such as an epoxy resin.

In the present embodiment, it is assumed that the wiring pattern of the drive signal generating circuit 40 described with reference to FIG. 8 includes the wiring line 401L, the wiring line 402L, and the wiring line 403L.

As illustrated in FIG. 9, the thermistor TT includes a thermistor main body AT, the terminal tT1, and the terminal tT2.

The thermistor main body AT is a conductive member having an electrical resistance value corresponding to the temperature of the thermistor main body AT. The terminal tT1 electrically couples the thermistor main body AT to a portion of the node nT patterned as the wiring line 401L. The terminal tT2 electrically couples the thermistor main body AT to a portion of the node nG patterned as the wiring line 401L.

As illustrated in FIG. 9, the thermally conductive element XN includes a thermally conductive element main body AN, the terminal tX1, and the terminal tX2.

The thermally conductive element main body AN is an insulating member having thermal conductivity. Specifically, in the present embodiment, the thermally conductive element main body AN has a higher thermal conductivity than those of the insulating components that are included in the drive circuit substrate 400 and are the resist 401R, the insulating portion 402R, the insulating portion 403R, and the protective layer 404. In addition, in the present embodiment, the thermal conductivity of the thermally conductive element main body AN is higher than or equal to 50% of the thermal conductivity of each of the conductive components that are included in the drive circuit substrate 400 and are the wiring line 401L, the wiring line 402L, and the wiring line 403L. For example, in the present embodiment, aluminum nitride is used as the thermally conductive element main body AN.

As illustrated in FIG. 9, in the present embodiment, it is assumed that the thermally conductive element main body AN is disposed in the Z2 direction with respect to the upper substrate surface 4001 and spaced apart from the upper substrate surface 4001.

The terminal tX1 is coupled to the thermally conductive element main body AN, and is also coupled to a portion of the node nV patterned as the wiring line 401L. In the present embodiment, the terminal tX1 is made of the same material as that of the thermally conductive element main body AN. However, the terminal tX1 may be made of a material different from that of the thermally conductive element main body AN. For example, the terminal tX1 may be made of a conductive material such as the same material as that of the wiring line 401L. The terminal tX1 preferably has a thermal conductivity higher than or equal to 50% of the thermal conductivity of each of the wiring line 401L, the wiring line 402L, and the wiring line 403L. The terminal tX1 preferably has a higher thermal conductivity than those of the resist 401R, the insulating portion 402R, the insulating portion 403R, and the protective layer 404.

The terminal tX2 is coupled to the thermally conductive element main body AN, and is also coupled to the portion of the node nT patterned as the wiring line 401L. In the present embodiment, the terminal tX2 is made of the same material as that of the thermally conductive element main body AN. However, the terminal tX2 may be made of a material different from that of the thermally conductive element main body AN. For example, the terminal tX2 may be made of a conductive material such as the same material as that of the wiring line 401L. The terminal tX2 preferably has a thermal conductivity higher than or equal to 50% of the thermal conductivity of each of the wiring line 401L, the wiring line 402L, and the wiring line 403L. The terminal tX2 preferably has a higher thermal conductivity than those of the resist 401R, the insulating portion 402R, the insulating portion 403R, and the protective layer 404.

### A.5. Summary of Embodiments

As described above, according to the present embodiment, heat generated in the drain electrode dt of the transistor TrH is transferred to the thermistor TT via the node nV, the thermally conductive element XN, and the node nT. In the present embodiment, the thermal conductivity of the thermally conductive element XN is higher than the thermal conductivities of the insulating components such as the resist 401R in the drive circuit substrate 400. Therefore, according to the present embodiment, it is possible to increase the ratio of the amount of heat transferred to the thermistor TT to the amount of heat generated in the drain electrode dt of the transistor TrH, as compared to an aspect in which the thermally conductive element XN is not disposed. Thus, according to the present embodiment, the temperature signal Tmp output from the thermistor TT can accurately indicate the temperature of the transistor TrH in the drive signal generating circuit 40, as compared to an aspect in which the thermally conductive element XN is not disposed.

### B. Modifications

Each embodiment described above can be modified in various manners. Specific modifications will be described below. Two or more aspects selected in any manner from the following examples can be appropriately combined with one another within a range in which the aspects are not inconsistent with one another. In the modifications described below, elements having the same effects and functions as those described in the embodiments will be given the reference signs used in the above description, and each detailed description thereof will be appropriately omitted.

### First Modification

In the above-described embodiments, the aspect in which the thermally conductive element XN is coupled to the node nV and the node nT has been described as an example, but the present disclosure is not limited to this aspect. For example, the thermally conductive element XN may be coupled to the node nD and the node nT.

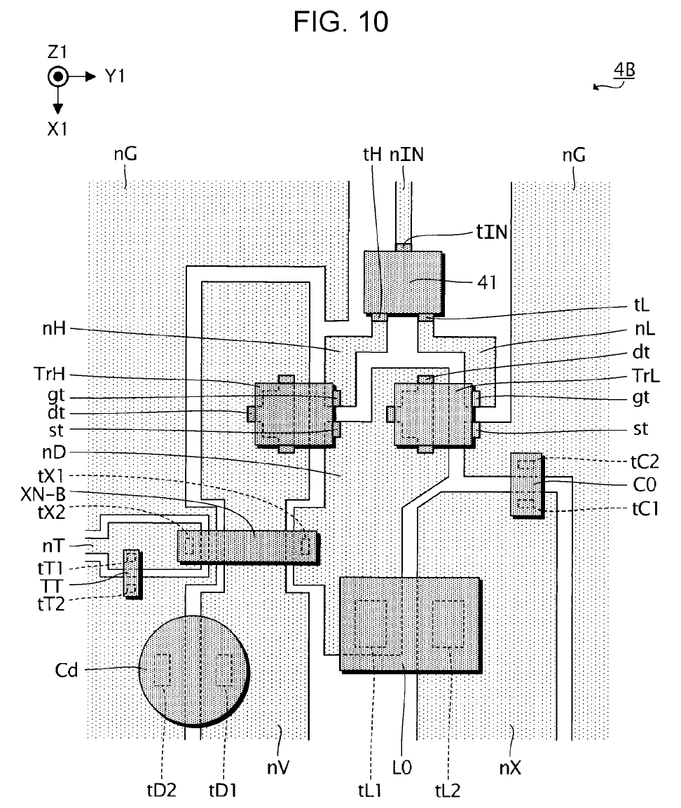

FIG. 10 is a plan view illustrating an example of a drive signal generation unit 4B according to the present modification.

As illustrated in FIG. 10, the drive signal generation unit 4B is different from the drive signal generation unit 4 according to the embodiment in that the drive signal generation unit 4B includes a thermally conductive element XN-B instead of the thermally conductive element XN. The thermally conductive element XN-B is different from the thermally conductive element XN according to the embodiment in that the thermally conductive element XN-B is coupled to the node nD and the node nT instead of being coupled to the node nV and the node nT. Specifically, the thermally conductive element XN-B has a terminal tX1 coupled to the node nD, and a terminal tX2 coupled to the node nT. The thermally conductive element XN-B transfers heat between the terminal tX1 and the terminal tX2 and electrically insulates the terminal tX1 and the terminal tX2 from each other. That is, in the present modification, the thermally conductive element XN-B thermally couples the node nT and the node nD, while electrically decoupling the node nT and the node nD. In the present modification, the node nD is an example of the "coupling wiring line".

As described above, in the present modification, heat generated from the source electrode st of the transistor TrH, heat generated from the drain electrode dt of the transistor TrL, and heat generated from the inductor L0 are transferred to the thermistor TT via the node nD, the thermally conductive element XN-B, and the node nT. Accordingly, in the present modification, the temperature signal Tmp output from the thermistor TT can accurately indicate a temperature corresponding to the temperature of each of the transistor TrH, the transistor TrL, and the inductor L0 that are electronic components that are included in the drive signal generating circuit 40 and generate a large amount of heat.

### Second Modification

In the above-described embodiments and the first modification, the aspect in which the thermally conductive element XN (and the thermally conductive element XN-B) is coupled to the node nT for the purpose of transferring heat to the thermistor TT has been described as an example, but the present disclosure is not limited to this aspect. For example, the thermally conductive element may be disposed to dissipate heat generated in the drive signal generating circuit 40.

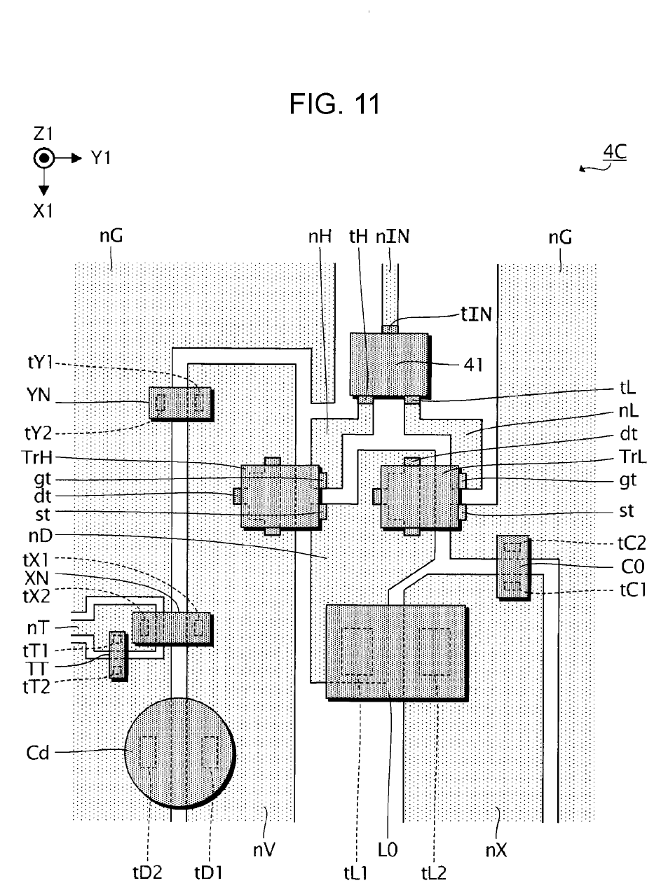

FIG. 11 is a plan view illustrating an example of a drive signal generation unit 4C according to the present modification.

As illustrated in FIG. 11, the drive signal generation unit 4C is different from the drive signal generation unit 4 according to the embodiment in that the drive signal generation unit 4C includes a thermally conductive element YN for heat dissipation, in addition to the thermally conductive element XN. The thermally conductive element YN for heat dissipation includes a terminal tY1 and a terminal tY2, transfers heat between the terminal tY1 and the terminal tY2, and electrically insulates the terminal tY1 and the terminal tY2 from each other. The terminal tY1 of the thermally conductive element YN for heat dissipation is coupled to the node nV. The terminal tY2 of the thermally conductive element YN for heat dissipation is coupled to the node nG. That is, in the present modification, the thermally conductive element YN for heat dissipation thermally couples the node nV and the node nG, while electrically decoupling the node nV and the node nG.

In the present modification, the thermally conductive element YN for heat dissipation has a similar configuration to that of the thermally conductive element XN. That is, in the present modification, the thermally conductive element YN for heat dissipation includes a main body made of aluminum nitride, and a terminal tY1 and a terminal tY2 that have similar configurations to those of the terminal tX1 and the terminals tX2.

As described above, in the present modification, heat generated from the drain electrode dt of the transistor TrH is transferred to the node nG via the node nV and the thermally conductive element YN for heat dissipation and is dissipated from the node nG. Accordingly, in the present modification, it is possible to efficiently dissipate heat generated in the drive signal generating circuit 40, as compared to an aspect in which the thermally conductive element YN for heat dissipation is not disposed. In the present modification, the thermally conductive element YN for heat dissipation is an example of a "second thermally conductive member", the node nG is an example of a "wiring line for heat dissipation", and the node nV is an example of the "coupling wiring line".

### Third Modification

In the above-described embodiments and the first and second modifications, the case where the drive signal generating circuit 40 is the class-D amplifier circuit has been described as an example, but the present disclosure is not limited to this aspect. The drive signal generating circuit 40 may be an amplifier circuit other than the class-D amplifier circuit. For example, the drive signal generating circuit 40 may be a class-AB amplifier circuit.

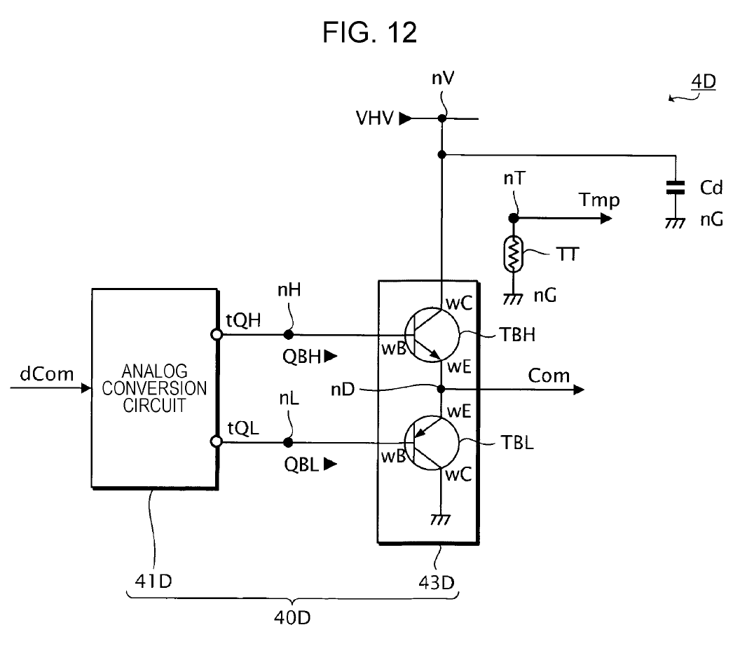

FIG. 12 is a block diagram illustrating an example of a circuit configuration of a drive signal generating circuit 40D and the thermistor TT included in a drive signal generation unit 4D according to the present modification.

As illustrated in FIG. 12, the drive signal generating circuit 40D includes an analog conversion circuit 41D, an amplifier circuit 43D, and an electrolytic capacitor Cd, and generates a drive signal Com based on a waveform specifying signal dCom. Specifically, for example, the drive signal generating circuit 40D generates the drive signal Com by performing class AB amplification on an analog input signal obtained by converting the waveform specifying signal dCom.

The analog conversion circuit 41D outputs a waveform specifying signal QB including a base supply signal QBH and a base supply signal QBL based on the digital waveform specifying signal dCom. Specifically, the analog conversion circuit 41D converts the waveform specifying signal dCom into the analog input signal, and generates the base supply signal QBH, which is an analog signal indicating an electrical potential based on the electrical potential of the input signal, and the base supply signal QBL, which is an analog signal indicating an electrical potential that is based on the electrical potential of the input signal and lower than the electrical potential of the base supply signal QBH. Then, the analog conversion circuit 41D outputs the base supply signal QBH from an output terminal tQH to the node nH, and outputs the base supply signal QBL from an output terminal tQL to the node nL.

The amplifier circuit 43D is a so-called push-pull circuit including an NPN-type bipolar transistor TBH and a PNP-type bipolar transistor TBL, and generates the drive signal Com based on the base supply signal QBH and the base supply signal QBL.

The bipolar transistor TBH has a base electrode wB electrically coupled to the output terminal tQH, and the base supply signal QBH is supplied from the output terminal tQH. The bipolar transistor TBH has a collector electrode wC electrically coupled to the node nV set to the power supply electrical potential VHV, and an emitter electrode wE electrically coupled to the node nD for supplying the drive signal Com. For example, the bipolar transistor TBH is turned on when the electrical potential of the base supply signal QBH increases, and as a result, the bipolar transistor TBH increases the electrical potential of the drive signal Com. In addition, for example, the bipolar transistor TBH is turned off when the electrical potential of the base supply signal QBH becomes constant and when the electrical potential of the base supply signal QBH decreases.

The bipolar transistor TBL has a base electrode wB electrically coupled to the output terminal tQL, and the base supply signal QBL is supplied from the output terminal tQL. The bipolar transistor TBL has a collector electrode wC electrically coupled to the node nG set to the ground electrical potential, and an emitter electrode wE electrically coupled to the node nD for supplying the drive signal Com. For example, the bipolar transistor TBL is turned on when the electrical potential of the base supply signal QBL decreases, and as a result, the bipolar transistor TBL decreases the electrical potential of the drive signal Com. In addition, for example, the bipolar transistor TBL is turned off when the electrical potential of the base supply signal QBL becomes constant and when the electrical potential of the base supply signal QBL increases.

The electrolytic capacitor Cd is a capacitor for supplying a current to the amplifier circuit 43D. Specifically, the terminal tD1 which is one of the two terminals of the electrolytic capacitor Cd is electrically coupled to the node nV set to the power supply electrical potential VHV and is electrically coupled to the collector electrode wC of the bipolar transistor TBH, and the terminal tD2 which is the other of the two terminals of the electrolytic capacitor Cd is electrically coupled to the node nG set to the ground electrical potential.

The terminal tT1 that is one of the terminals of the thermistor TT is electrically coupled to the node nT, and the terminal tT2 that is the other of the terminals of the thermistor TT is electrically coupled to the node nG.

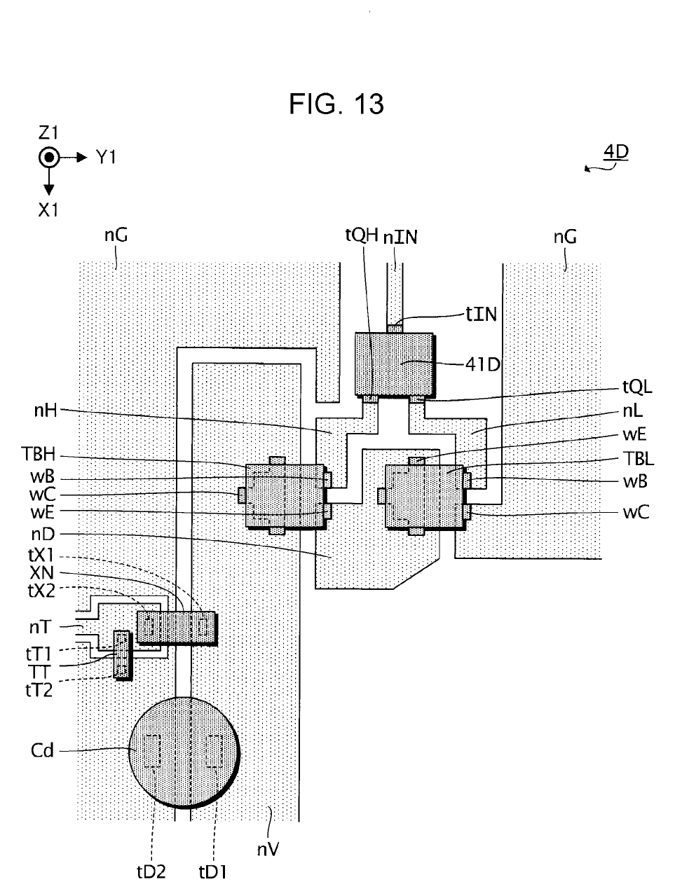

FIG. 13 is a plan view illustrating an example of a configuration of the drive signal generation unit 4D according to the present modification.

As illustrated in FIG. 13, the terminal tIN of the analog conversion circuit 41D is coupled to the node nIN through which the waveform specifying signal dCom is supplied. The output terminal tQH of the analog conversion circuit 41D is electrically coupled to the base electrode wB of the bipolar transistor TBH via the node nH, and the output terminal tQL of the analog conversion circuit 41D is electrically coupled to the base electrode wB of the bipolar transistor TBL via the node nL.

The collector electrode wC of the bipolar transistor TBL is electrically coupled to the node nG. The emitter electrode wE of the bipolar transistor TBL is electrically coupled to the emitter electrode wE of the bipolar transistor TBH via the node nD.

The collector electrode wC of the bipolar transistor TBH is electrically coupled to the terminal tD1 of the electrolytic capacitor Cd via the node nV. The terminal tD2 of the electrolytic capacitor Cd is electrically coupled to the node nG.

As illustrated in FIG. 13, the terminal tT1 of the thermistor TT is coupled to the node nT. The terminal tT2 of the thermistor TT is coupled to the node nG. The temperature signal Tmp indicating the value corresponding to the temperature of the thermistor TT is supplied from the node nT to the control unit 2.

As illustrated in FIG. 13, the terminal tX1 of the thermally conductive element XN is coupled to the node nV. The terminal tX2 of the thermally conductive element XN is coupled to the node nT. That is, in the present modification, the thermally conductive element XN thermally couples the node nV and the node nT, while electrically decoupling the node nV and the node nT.

Therefore, in the present modification, heat generated from the collector electrode wC of the bipolar transistor TBH is transferred to the thermistor TT via the node nV, the thermally conductive element XN, and the node nT. Accordingly, in the present modification, it is possible to set the temperature signal Tmp output from the thermistor TT as a signal accurately indicating the temperature of the bipolar transistor TBH in the drive signal generating circuit 40.

In the present modification, the bipolar transistor TBH and the bipolar transistor TBL are examples of the "two transistors", the bipolar transistor TBH is an example of the "first transistor", the bipolar transistor TBL is an example of the "second transistor", and the node nV is an example of the "coupling wiring line".

### Fourth Modification

In the above-described embodiments and the first to third modifications, the aspect in which the drive signal generation unit 4 is disposed separately from the head unit 3 has been described as an example, but the present disclosure is not limited to this aspect. The drive signal generation unit 4 may be mounted on the head unit 3.

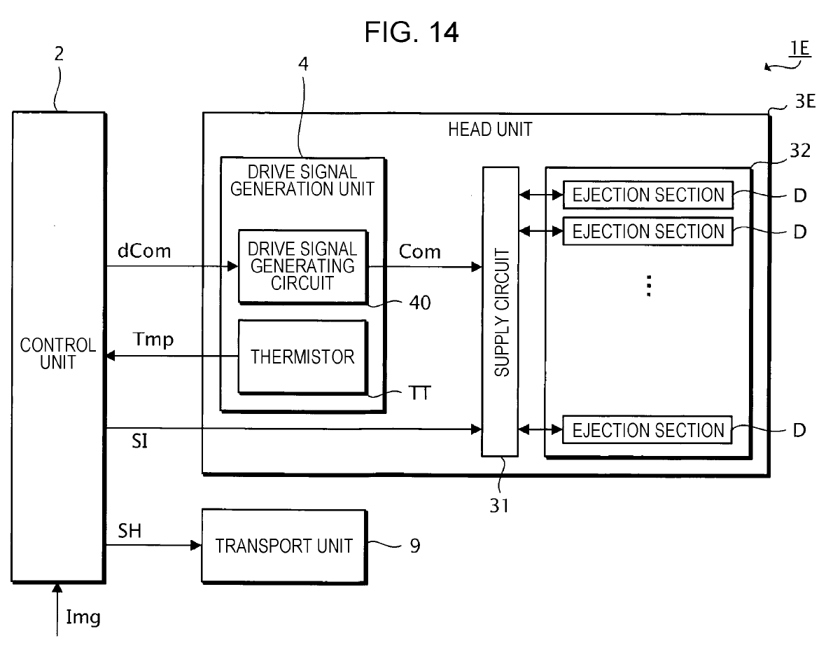

FIG. 14 is a functional block diagram illustrating an example of a configuration of an ink jet printer 1E according to the present modification.

As illustrated in FIG. 14, the ink jet printer 1E is different from the ink jet printer 1 according to the embodiment in that the ink jet printer 1E includes a head unit 3E instead of the head unit 3. The head unit 3E is different from the head unit 3 according to the embodiment in that the head unit 3E includes a drive signal generation unit 4 including the drive signal generating circuit 40 and the thermistor TT in addition to the supply circuit 31 and the head section 32.

Also in the present modification, similarly to the embodiment, the temperature signal Tmp output from the thermistor TT can be set as a signal accurately indicating the temperature of the drive signal generating circuit 40.

### Fifth Modification

In the above-described embodiments and the first to fourth modifications, it is assumed that the ink jet printer 1 is a serial printer, but the present disclosure is not limited to this aspect. The ink jet printer 1 may be a so-called line printer in which a plurality of nozzles N are disposed in a head unit 3 so as to be arranged in a range wider than the width of the recording sheet PP. In this case, the head unit 3 does not reciprocate inside a housing 100, and the relative positional relationship between the head unit 3 and the housing 100 does not change.

### C. Supplementary Notes

Aspects related to the above description are appended below. In order to facilitate understanding of each of the aspects, in the following description, reference signs in the drawings are given in parentheses for convenience, but it is not intended that the present disclosure is limited to the aspects illustrated in the drawings.

### Supplementary Note 1

An ink jet printer 1 according to Supplementary Note 1 includes an ejection section D that is driven by a drive signal Com and ejects ink, a drive circuit substrate 400 on which a drive signal generating circuit 40 that generates the drive signal Com is disposed, a thermistor TT that is disposed on the drive circuit substrate 400 and detects a temperature of the drive circuit substrate 400, and a thermally conductive element XN that is disposed on the drive circuit substrate 400, has an electrical insulation property, and has a terminal tX1 coupled to the drive signal generating circuit 40, and a terminal tX2 coupled to a node nT electrically coupled to the thermistor TT.

According to Supplementary Note 1, since the thermally conductive element XN transfers heat generated by the drive signal generating circuit 40 to the thermistor TT, it is possible to more accurately detect the temperature of the drive signal generating circuit 40, as compared to an aspect in which the thermally conductive element XN is not disposed.

### Supplementary Note 2

An ink jet printer 1 according to Supplementary Note 2 is the ink jet printer 1 according to Supplementary Note 1, in which the thermally conductive element XN is made of aluminum nitride.

According to Supplementary Note 2, the thermally conductive element XN can have both the electrical insulation property and thermal conductivity.

### Supplementary Note 3

An ink jet printer 1 according to Supplementary Note 3 is the ink jet printer 1 according to Supplementary Note 1 or 2, in which the drive signal generating circuit 40 includes an amplifier circuit 43 including a transistor TrH and a transistor TrL for generating the drive signal Com by amplifying an input signal including a gate signal SGH and a gate signal SGL, and the terminal tX1 of the thermally conductive element XN is coupled to a node nV electrically coupled to the transistor TrH or is coupled to a node nD electrically coupled to the transistor TrL.

According to Supplementary Note 3, since the thermally conductive element XN transfers, to the thermistor TT, heat generated by the transistor TrH or the transistor TrL that is included in the drive signal generating circuit 40 and generates a large amount of heat, it is possible to more accurately detect the temperature of the drive signal generating circuit 40, as compared to an aspect in which the thermally conductive element XN is not disposed.

### Supplementary Note 4

An ink jet printer 1 according to Supplementary Note 4 is the ink jet printer 1 according to any one of Supplementary Notes 1 to 3, in which the drive signal generating circuit 40 includes an amplifier circuit 43 including a transistor TrH and a transistor TrL for generating the drive signal Com by amplifying an input signal including a gate signal SGH and a gate signal SGL, the transistor TrH is electrically coupled to a node nV set to a power supply electrical potential VHV, the transistor TrL is electrically coupled to a node nG set to a ground electrical potential, and the terminal tX1 of the thermally conductive element XN is coupled to a node nD or the node nV electrically coupled to the transistor TrH.

According to Supplementary Note 4, since the thermally conductive element XN transfers, to the thermistor TT, heat generated by the transistor TrH that is included in the drive signal generating circuit 40 and generates a large amount of heat, it is possible to more accurately detect the temperature of the drive signal generating circuit 40, as compared to an aspect in which the thermally conductive element XN is not disposed.

### Supplementary Note 5

An ink jet printer 1 according to Supplementary Note 5 is the ink jet printer 1 according to any one of Supplementary Notes 1 to 4, in which the drive signal generating circuit 40 includes an amplifier circuit 43 including a transistor TrH and a transistor TrL that are field-effect transistors for generating the drive signal Com by amplifying an input signal including a gate signal SGH and a gate signal SGL, and the terminal tX1 of the thermally conductive element XN is coupled to a node nV electrically coupled to a drain electrode dt of the transistor TrH or is coupled to a node nD electrically coupled to a drain electrode dt of the transistor TrL.

According to Supplementary Note 5, since the thermally conductive element XN transfers, to the thermistor TT, heat generated by the transistor TrH or the transistor TrL that is included in the drive signal generating circuit 40 and generates a large amount of heat, it is possible to more accurately detect the temperature of the drive signal generating circuit 40, as compared to an aspect in which the thermally conductive element XN is not disposed.

### Supplementary Note 6

An ink jet printer 1 according to Supplementary Note 6 is the ink jet printer 1 according to any one of Supplementary Notes 1 to 4, in which the drive signal generating circuit 40 includes an amplifier circuit 43 including a transistor TrH and a transistor TrL that are field-effect transistors for generating the drive signal Com by amplifying an input signal including a gate signal SGH and a gate signal SGL, and the terminal tX1 of the thermally conductive element XN is coupled to a node nD electrically coupled to a source electrode st of the transistor TrH.

According to Supplementary Note 6, since the thermally conductive element XN transfers, to the thermistor TT, heat generated by the transistor TrH that is included in the drive signal generating circuit 40 and generates a large amount of heat, it is possible to more accurately detect the temperature of the drive signal generating circuit 40, as compared to an aspect in which the thermally conductive element XN is not disposed.

### Supplementary Note 7

An ink jet printer 1 according to Supplementary Note 7 is the ink jet printer 1 according to Supplementary Note 1 or 2, in which the drive signal generating circuit 40 includes an amplifier circuit 43D including a bipolar transistor TBH and a bipolar transistor TBL for generating the drive signal Com by amplifying a waveform specifying signal QB that is an input signal including a base supply signal QBH and a base supply signal QBL, and the terminal tX1 of the thermally conductive element XN is coupled to a node nV electrically coupled to a collector electrode wC of the bipolar transistor TBH.

According to Supplementary Note 7, since the thermally conductive element XN transfers, to the thermistor TT, heat generated by the bipolar transistor TBH that is included in the drive signal generating circuit 40 and generates a large amount of heat, it is possible to more accurately detect the temperature of the drive signal generating circuit 40, as compared to an aspect in which the thermally conductive element XN is not disposed.

### Supplementary Note 8

An ink jet printer 1 according to Supplementary Note 8 is the ink jet printer 1 according to Supplementary Note 1 or 2, in which the drive signal generating circuit 40 includes an amplifier circuit 43D including a bipolar transistor TBH and a bipolar transistor TBL for generating the drive signal Com by amplifying a waveform specifying signal QB that is an input signal including a base supply signal QBH and a base supply signal QBL, and the terminal tX1 of the thermally conductive element XN is coupled to a node nD electrically coupled to an emitter electrode wE of the bipolar transistor TBH and an emitter electrode wE of the bipolar transistor TBL.

According to Supplementary Note 8, since the thermally conductive element XN transfers, to the thermistor TT, heat generated by the bipolar transistor TBH and the bipolar transistor TBL that are included in the drive signal generating circuit 40 and generate a large amount of heat, it is possible to more accurately detect the temperature of the drive signal generating circuit 40, as compared to an aspect in which the thermally conductive element XN is not disposed.

### Supplementary Note 9

An ink jet printer 1 according to Supplementary Note 9 is the ink jet printer 1 according to any one of Supplementary Notes 1 to 8, further including a thermally conductive element YN for heat dissipation that has an electrical insulation property and has a terminal tY1 coupled to the drive signal generating circuit 40, and a terminal tY2 coupled to a node nG that is a wiring line for heat dissipation.

According to Supplementary Note 9, it is possible to efficiently dissipate heat generated by the drive signal generating circuit 40, as compared to an aspect in which the thermally conductive element XN is not disposed.

What is claimed is:

1. A liquid ejecting apparatus comprising:
an ejection section that is driven by a drive signal and ejects liquid;
a circuit substrate on which a drive circuit that generates the drive signal is disposed;
a thermistor that is disposed on the circuit substrate and detects a temperature of the drive circuit; and
a first thermally conductive member that is disposed on the circuit substrate, has an electrical insulation property, and has a first end coupled to the drive circuit, and a second end coupled to a wiring line electrically coupled to the thermistor.

2. The liquid ejecting apparatus according to claim 1, wherein
the first thermally conductive member is made of aluminum nitride.

3. The liquid ejecting apparatus according to claim 1, wherein
the drive circuit includes an amplifier circuit including two transistors for generating the drive signal by amplifying an input signal, and
the first end of the first thermally conductive member is coupled to a coupling wiring line electrically coupled to at least one transistor out of the two transistors.

4. The liquid ejecting apparatus according to claim 3, wherein
the two transistors are
a first transistor electrically coupled to a first electrical potential line set to a first electrical potential, and
a second transistor electrically coupled to a second electrical potential line set to a second electrical potential lower than the first electrical potential, and
the one transistor is the first transistor.

5. The liquid ejecting apparatus according to claim 3, wherein
the one transistor is a field-effect transistor, and
the coupling wiring line is electrically coupled to a drain electrode of the field-effect transistor.

6. The liquid ejecting apparatus according to claim 3, wherein
the one transistor is a field-effect transistor, and
the coupling wiring line is electrically coupled to a source electrode of the field-effect transistor.

7. The liquid ejecting apparatus according to claim 3, wherein
the one transistor is a bipolar transistor, and
the coupling wiring line is electrically coupled to a collector electrode of the bipolar transistor.

8. The liquid ejecting apparatus according to claim 3, wherein
the one transistor is a bipolar transistor, and
the coupling wiring line is electrically coupled to an emitter electrode of the bipolar transistor.

9. The liquid ejecting apparatus according to claim 1, further comprising
a second thermally conductive member that is disposed on the circuit substrate, has an electrical insulation property, and has a first end coupled to the drive circuit, and a second end coupled to a wiring line for heat dissipation on the circuit substrate.

10. A drive unit that drives an ejection section that ejects liquid, the drive unit comprising:
a drive circuit that generates a drive signal for driving the ejection section;
a circuit substrate on which the drive circuit is disposed;
a thermistor that is disposed on the circuit substrate and detects a temperature of the drive circuit; and
a first thermally conductive member that is disposed on the circuit substrate, has an electrical insulation property, and has a first end coupled to the drive circuit, and a second end coupled to a wiring line electrically coupled to the thermistor.

11. The drive unit according to claim 10, wherein
the first thermally conductive member is made of aluminum nitride.

12. The drive unit according to claim 10, wherein
the drive circuit includes an amplifier circuit including two transistors for generating the drive signal by amplifying an input signal, and
the first end of the first thermally conductive member is coupled to a coupling wiring line electrically coupled to at least one transistor out of the two transistors.

13. The drive unit according to claim 12, wherein
the two transistors are
a first transistor electrically coupled to a first electrical potential line set to a first electrical potential, and
a second transistor electrically coupled to a second electrical potential line set to a second electrical potential lower than the first electrical potential, and
the one transistor is the first transistor.

14. The drive unit according to claim 12, wherein
the one transistor is a field-effect transistor, and
the coupling wiring line is electrically coupled to a drain electrode of the field-effect transistor.

15. The drive unit according to claim 12, wherein
the one transistor is a field-effect transistor, and
the coupling wiring line is electrically coupled to a source electrode of the field-effect transistor.

16. The drive unit according to claim 12, wherein
the one transistor is a bipolar transistor, and
the coupling wiring line is electrically coupled to a collector electrode of the bipolar transistor.

17. The drive unit according to claim 12, wherein
the one transistor is a bipolar transistor, and
the coupling wiring line is electrically coupled to an emitter electrode of the bipolar transistor.

18. The drive unit according to claim 10, further comprising
a second thermally conductive member that is disposed on the circuit substrate, has an electrical insulation property, and has a first end coupled to the drive circuit, and a second end coupled to a wiring line for heat dissipation on the circuit substrate.
